(19) United States
(12) Patent Application Publication
(10) Pub. No.: US 2015/0021217 A1
(43) Pub. Date: Jan. 22, 2015

(54) PORTABLE HUMIDOR DEVICES

(71) Applicant: Jason Ryan Smith, Monona, WI (US)

(72) Inventor: Jason Ryan Smith, Monona, WI (US)

(21) Appl. No.: 14/336,564

(22) Filed: Jul. 21, 2014

Related U.S. Application Data
(60) Provisional application No. 61/856,865, filed on Jul. 22, 2013.
(60) Provisional application No. 61/915,330, filed on Dec. 12, 2013.

(51) Int. Cl. A24F 25/02; H04R 3/12

(52) U.S. Cl. CPC A24F 25/02; H04R 3/12
USPC 206/236

(57) ABSTRACT

The present invention provides portable humidors 1) designed to withstand the rigors of travel, as well as varying weather and climate conditions, while securely retaining, and maintaining the smokable integrity of any cigars stored inside, and 2) designed with an audio speaker system.

### CROSS REFERENCE TO RELATED APPLICATIONS

The present invention claims priority to U.S. Provisional Application No. 61/856,865, filed Jul. 22, 2013 and U.S. Provisional Application No. 61/915,330, filed Dec. 12, 2013, each of which are incorporated by reference in their entireties.

### FIELD OF THE INVENTION

The present invention provides portable humidors 1) designed to withstand the rigors of travel, as well as varying weather and climate conditions, while securely retaining, and maintaining the smokable integrity of any cigars stored inside, and 2) designed with an audio speaker system.

### BACKGROUND OF THE INVENTION

Cigar smoking and listening to music are typically regarded as different means of relaxation. Indeed, many individuals simultaneously enjoy the smoking of a cigar while listening to music. Individuals who are not situated in a setting conducive to either the maintenance of cigar quality and/or listening to music (e.g., travelling individuals, individuals not at home), however, are forced to compromise the amount of respective relaxation.

As such, improved devices capable of simultaneously permitting the transport of cigars and listening of music are needed.

### SUMMARY

The smokable life of a cigar is directly related to the conditions under which the cigar is stored. If stored at the proper temperature and humidity levels, a cigar can be maintained in a smokable condition indefinitely. However, if stored improperly the smokability of the cigar deteriorates rapidly rendering the cigar unsmokable in a very short time. The ideal environment for cigar storage is one that recreates the tropical climate in which the tobacco plants, from which cigars are made, were grown.

In attempting to recreate the conditions described above, cigars are typically stored in what are referred to as humidors. A humidor is essentially a box which contains a device for maintaining a constant humidity level in its interior, and which when closed, should seal the interior of the box from the ingress of outside air. Most often humidors are constructed of wood with the interior lined with cedar. Typically, these wooden humidors are quite expensive, elaborate items meant to appear and function as furniture, and as such are not overly rugged. Moreover, since most humidors are not meant to be moved from place to place, the cigars are stored loosely inside. Therefore, if the humidor is moved or transported, the cigars will move relative to each other potentially damaging the cigar's delicate wrapper.

Based on the foregoing, the problem exists in that if an individual must travel, the individual must either transport the cigars and risk them being damaged and/or drying out. Any purchased cigars while on travel will potentially be exposed to extremes in weather and/or climate conditions which will significantly impair the smokability of the respective cigar.

Moreover, a traveling individual typically views the smoking of a cigar as a means for relaxation. As such, the enjoyment related to the smoking of a cigar may be enhanced upon the listening of music and/or spoken word (e.g., talk based radio, audio books).

Currently, however, there are no portable humidors available which not only preserve the integrity and quality of one or more cigars but also provide a means for listening to music and/or spoken word (e.g., talk based radio, audio books).

The present invention addresses and provides a solution for this need.

Indeed, embodiments of the present invention provide portable humidors 1) designed to withstand the rigors of travel, as well as varying weather and climate conditions, while securely retaining, and maintaining the smokable integrity of any cigars stored inside, and 2) designed with an audio speaker system.

In certain embodiments, for example, the present invention provides portable humidors comprising an interior region and an exterior region. The portable humidors are not limited to a particular interior region. In some embodiments, the interior region comprises a region for storing one or more smokable items and one or more audio speakers. The portable humidors are not limited to a particular exterior region. In some embodiments, the exterior region has a top portion and a bottom portion connected in a manner permitting the portable humidor to open and close in an airtight and/or water resistant manner.

The portable humidors are not limited to storing a particular type and/or kind of smokable item. In some embodiments, the smokable item includes cigars and/or cigarettes. The portable humidors are not limited to storing a particular number of smokable items. In some embodiments, the portable humidor can store as few as one smokable item and as many as 100 smokable items, depending on the respective size of the portable humidor.

In some embodiments, the interior region is further designed with a region to store an igniting agent. In some embodiments, the interior region is further designed with a cigar cutting agent. In some embodiments, the one or more speakers are configured to emit an audio signal with the exterior region in an open or closed position. In some embodiments, the interior region is further designed with a battery configured to provide operating energy to the one or more audio speakers. In some embodiments, the interior region is further designed with a smart phone and/or smart tablet docking station.

In some embodiments, the one or more speakers are configured to receive and emit a wireless audio signal from a smart phone and/or smart tablet. In some embodiments, the interior region further comprises a processor for facilitating communication between the wireless signal and the audio speakers. For example, in some embodiments, the processor communicates with a smart phone and/or smart tablet via an application stored on the smart phone and/or smart tablet. In some embodiments, the application permits wireless regulation of the audio speakers from the smart phone and/or smart tablet.

In some embodiments, the interior region further comprises a removable lift-out tray configured to be positioned above the region for storing one or more smokable items. In some embodiments, the positioning of the removable lift-out tray above the region for storing one or more smokable items results in an air-tight seal.

In some embodiments, the top portion is connected with the bottom portion via a hinge connection. In some embodiments, the top portion is connected with the bottom portion via a hingeless connection. In some embodiments, the top portion and the bottom portion have thereon one or more opposing magnets. In some embodiments, the top portion is connected with the bottom portion via magnetic force.

### BRIEF DESCRIPTION OF THE DRAWINGS

FIGS. 1A, 1B and 1C present portable humidor embodiments of the present invention.

FIGS. 2A, 2B and 2C present portable humidor embodiments of the present invention.

FIG. 3 presents a top down perspective of a portable humidor embodiment of the present invention in a closed position.

FIGS. 4, 5 and 6 present top-down side-view perspectives or side-view perspectives of portable humidor embodiments of the present invention in a closed position.

FIG. 7 shows the interior region of a portable humidor embodiment of the present invention.

FIG. 8 shows an embodiment of a portable humidor having a lift-out tray.

### DETAILED DESCRIPTION

Cigar smokers who are traveling, or just smoking outside, often do not have everything in one convenient place to enjoy their favorite cigar and listen to their favorite music, Internet radio or streaming video. Embodiments of the present invention solve this problem. Indeed, the present invention provides portable humidors 1) designed to withstand the rigors of travel, as well as varying weather and climate conditions, while securely retaining, and maintaining the smokable integrity of any cigars stored inside, and 2) designed with an audio speaker system.

Embodiments for the present invention refer to “cigars” for mere convenience. However, it should be noted that any and/or all of the embodiments of the invention are contemplated to pertain to any item that can be smoked (e.g., cigars, cigarettes, etc.).

The present invention is not limited to a particular size of portable humidor. Indeed, the present invention is contemplated to embody any and all sizes of humidors depending on the intended use of the individual. For example, in some embodiments, the size of the portable humidor is such that it can fit within a briefcase. In some embodiments, the size of the portable humidor is such that it can fit within the pocket of an individual's pants. In some embodiments, the size of the portable humidor is such that it can easily be carried. In some embodiments, the size of the portable humidor is such that it can be transported within a suitcase. In some embodiments, the size of the portable humidor is approximately 8 inches in length (e.g., 3, 4, 5, 6, 7, 8, 9, 10, 11, 12, 15, 20, 30 inches in length), 5 inches in width (e.g., 1, 2, 3, 4, 5, 6, 7, 8, 9, 10, 11, 12, 15, 20, 30 inches in width), and 3 inches in height (e.g., 1, 2, 3, 4, 5, 6, 7, 8, 9, 10, 15, 20, 30 inches in height). In some embodiments, the size of the portable humidor is 11 inches in length, 2.75 inches in height, and 4.5 inches in width. In some embodiments, the size of the portable humidor is such that it is able to permit a user to not only transport cigars while maintaining the integrity and quality of the transported cigars but also to permit the user to transmit sound through audio speakers positioned within the portable humidor.

Such embodiments are not limited to a storing a particular number of cigars within the portable humidor. For example, the portable humidors of the present invention can be designed to store from 1 to over 100 cigars depending on the size of the portable humidor.

Such embodiments are not limited to a particular manner of storing the cigars within the portable humidor. In some embodiments, the portable humidor is designed with pre-sized regions to accommodate (e.g., store) one or more cigars. In some embodiments, such pre-sized regions have a curvilinear shape so as to prevent movement of the cigars within the portable humidor. In some embodiments, such pre-sized regions are separated by barriers to prevent movement of the cigars within the portable humidor.

In some embodiments, a “lift-out tray” is positioned above such pre-sized regions. In some embodiments, the lift-out tray has a bottom face and a top face. In some embodiments, the lift-out tray is configured such that upon positioning above the pre-sized regions, the bottom face is directly above the pre-sized regions, and the top face is directly below the bottom face of the humidor lid.

Such embodiments are not limited to a particular shape and/or size of the lift-out tray. In some embodiments, the size and shape of the lift-out tray is such that it is able to cover the pre-sized region. In some embodiments, the lift-out tray is configured to cover the pre-sized region such that an air tight seal and/or waterproof seal is generated over the pre-sized region. For example, in some embodiments, positioning the lift-out tray over the pre-sized region maintains an air tight seal and/or waterproof seal over the pre-sized region whether the humidor is open or closed. As such, in some embodiments, the lift-out tray enables the humidor to be in an open state (e.g., the humidor lid is open) (e.g., for purposes of accessing the speakers) while maintaining any cigars stored in the pre-sized region in an air tight seal and/or waterproof seal (e.g., cigars are still humidified when the humidor lid is open).

In some embodiments, the lift-out tray is configured to be positioned within the humidor (e.g., above the pre-sized region but below the lid of the humidor) such that a space exists between the lid of the humidor and the top face of the lift-out tray. In such embodiments, there is no limitation of the size of the space between the lid of the humidor and the top face of the lift-out tray. In some embodiments, the size of the space between the lid of the humidor and the top face of the lift-out tray does not compromise the integrity of pre-sized regions (e.g., does not compromise any cigars within the pre-sized regions and/or the desired conditions (e.g., humidity) within the pre-sized regions). In some embodiments, the size of the space between the lid of the humidor and the top face of the lift-out tray is such that one or more additional items (e.g., an igniter agent (e.g., a lighter); a cigar cutter) can be stored within such space. In some embodiments, the top face of the lift-out tray has thereon one or more elevated separators to assist in storing such additional items.

In some embodiments, the lift-out tray is configured to be removed from the humidor for purposes of gaining access to the pre-sized region (e.g., for purposes of accessing stored cigars). In such embodiments, the lift-out tray is configured such that it may be repositioned (e.g., re-secured) over the pre-sized region (e.g., thereby “closing” the pre-sized region). In some embodiments, the size of the lift-out tray is such that it covers the entirety of the top of the pre-sized region. In some embodiments, the size of the lift-out tray is such that it covers only a portion of the pre-sized region (e.g., 99%, 98%, 95%, 90%, 85%, 80%, 70%, 50%, 40%, 25%, etc.). In some embodiments, the size of the lift-out tray is such that upon its removal (e.g., thereby “opening” the pre-sized region) access to any portion or the pre-sized region is achieved. In some embodiments, the size of the pre-sized region is such that upon its removal (e.g., thereby “opening” the pre-sized region) access to the pre-sized region for purposes of securing and/or removing cigars is achieved. In some embodiments, the portable humidors are configured such that upon closing an air tight seal and/or waterproof seal is generated.

The lift-out tray is not limited to a particular manner of opening and closing. In such embodiments, the lift-out tray is configured such that upon closing an air tight seal and/or waterproof seal is generated. In some embodiments, the lift-out tray has a hinge based mechanism for opening and closing (e.g., such that it opens and closes like a book). In some embodiments, the lift-out tray has a hingeless based mechanism for opening and closing. In some embodiments, the lift-out tray and humidor each have positioned thereon opposing magnets such that the lift-out tray is secured with the humidor via magnetic force (e.g., thereby “closing” and “securing” the pre-sized region). Such embodiments are not limited to using a particular number of magnets. Such embodiments are not limited to positioning the magnets at any particular location thereon the lift-out tray and humidor. Such embodiments are not limited to using a particular type and/or kind of magnets. In some embodiments, the lift-out tray has thereon a means for grabbing the top lid for purposes of removing it from the humidor and repositioning it on the humidor (e.g., a handle or similar item).

The embodiments of the present invention are not limited to a particular manner of opening and/or closing the portable humidors. In some embodiments, the portable humidors have a locking mechanism for opening and closing (e.g., such that upon closing the humidor is “locked”) (e.g., such that the humidor must be “unlocked” prior to opening).

In some embodiments, the portable humidors have a hinge based mechanism for opening and closing (e.g., such that it opens and closes like a book). In such embodiments, the portable humidors are configured such that upon closing an air tight seal and/or waterproof seal is generated.

In some embodiments, the portable humidors have a hingeless based mechanism for opening and closing. For example, in some embodiments, the humidor has a top lid that is configured to be removed from the humidor for purposes of gaining access to the interior of the humidor (e.g., thereby “opening” the humidor). In such embodiments, the top lid is further configured such that it may be repositioned (e.g., re-secured) with the humidor (e.g., thereby “closing” the humidor). In some embodiments, the size of the lid is such that it covers the entirety of the top of the humidor. In some embodiments, the size of the lid is such that it covers only a portion of the top of the humidor (e.g., 99%, 98%, 95%, 90%, 85%, 80%, 70%, 50%, 40%, 25%, etc.). In some embodiments, the size of the lid is such that upon its removal (e.g., thereby “opening” the humidor) access to any portion or the interior of the humidor and/or the entirety of the interior of the humidor is achieved. In some embodiments, the size of the lid is such that upon its removal (e.g., thereby “opening” the humidor) access to the interior of the humidor for purposes of securing and/or removing cigars is achieved. In some embodiments, the portable humidors are configured such that upon closing an air tight seal and/or waterproof seal is generated. The top lid is not limited to a particular manner of positioning and/or securing with the humidor. For example, in some embodiments, the top lid is configured to securely fit over the main humidor body (e.g., thereby “closing” the humidor). In some embodiments, the top lid is configured to “slide” within one or more “tracks” positioned at the top of the humidor body (e.g., thereby “closing” the humidor). In some embodiments, the top lid and humidor each have positioned thereon opposing magnets such that the top lid is secured with the humidor via magnetic force (e.g., thereby “closing” and “securing” the humidor). Such embodiments are not limited to using a particular number of magnets. Such embodiments are not limited to positioning the magnets at any particular location thereon the top lid and humidor. Such embodiments are not limited to using a particular type and/or kind of magnets. In some embodiments, the top lid has thereon a means for grabbing the top lid for purposes of removing it from the humidor and repositioning it on the humidor (e.g., a handle or similar item).

Such embodiments are not limited to particular physical properties of the portable humidor. For example, in some embodiments, the portable humidors are waterproof (e.g., waterproof such that if a closed portable humidor is dropped into a body of liquid, such liquid will not enter the inter region of the closed portable humidor). In some embodiments, the portable humidors are resilient to external pressures (e.g., able to withstand a dropping from a height less than 10-15 feet without compromising the integrity of the portable humidor). In some embodiments, the portable humidor is developed with plastic, leather, metal, rubber, ceramic, wood, and/or any mixture thereof.

Such embodiments are not limited to a particular manner of storing cigars without compromising the integrity and/or quality of the stored cigars. For example, in some embodiments, the portable humidor is configured to maintain a desired humidity level and/or temperature level. In some embodiments, the portable humidor has therein a heating agent (e.g., a heating agent that can be adjusted to raise and/or lower the temperature of the humidor to achieve a desired humidity and/or temperature). In some embodiments, the heating agent is battery operated. In some embodiments, the portable humidor has therein a humidifier agent (e.g., a humidifier agent that can be adjusted to raise and/or lower the humidity of the humidor to achieve a desired humidity). In some embodiments, the humidifier agent is battery operated. In some embodiments, the humidifier agent is adjustable for purposes of increasing or decreasing the humidity level within the portable humidor. In some embodiments, the portable humidor has therein a hygrometer (e.g., for purposes of measuring and displaying the humidity level within the portable humidor). In some embodiments, the portable humidor has therein a thermostat (e.g., for purposes of measuring the temperature within the portable humidor). In some embodiments, the thermostat is battery operated.

Such embodiments are not limited to a particular manner of transmitting sound. In some embodiments, the portable humidors have therein one or more audio speakers positioned within its respective interior. The embodiments of the present invention are not limited to particular types and/or kinds of audio speakers. The embodiments of the present invention are not limited to particular sizes of audio speakers. In some embodiments, the size of the audio speakers is such that it can be positioned within the portable humidor without compromising the ability of the portable humidor to store its cigars. In some embodiments, the volume of the audio speakers is manually adjustable. In some embodiments, the audio speakers are configured to receive and transmit radio signals (e.g., FM, AM). In some embodiments, the audio speakers are configured to receive a wireless signal (e.g., Bluetooth transmission (e.g., Bluetooth transmission from a smart phone, smart tablet, portable computer, desktop computer, etc.)). In some embodiments, the audio speakers are configured with a cord based plug for purposes of receiving an audio transmission (e.g., a cord based plug to communicate with a smart phone, smart tablet, portable computer, desktop computer, etc.). In some embodiments, the portable humidors are designed with a USB access port for purposes of providing an audio signal (e.g., in such embodiments the audio speakers are configured to communicate and receive such an audio signal through the USB access port). In some embodiments, the portable humidors have therein one or more audio speakers configured to transmit sound through its respective exterior.

In some embodiments, the portable humidors are configured to house a cigar cutter (e.g., a steel cigar cutter). In some embodiments, the portable humidors are configured to house a cigar igniting agent (e.g., a lighter, matches, wind proof lighter, etc.).

In some embodiments, the portable humidors have therein a docking station configured for replenishing and/or maintaining the battery charge of a smart phone, smart tablet etc.

In some embodiments, the portable humidors have therein a battery for providing energy to one or more of an audio speaker(s), a charging station, a humidifier agent, a heating agent, a hygrometer, a thermostat, and/or a visual display. In some embodiments, the portable humidors have therein an adaptor (e.g., an AC adaptor) for replenishing the charge of such a battery and/or to provide an alternative energy source for a speaker system, a charging station, a humidifier agent, a hygrometer, a heating agent, a thermostat, and/or a visual display. In some embodiments, the portable humidors have therein an access port (e.g., an USB access port) for replenishing the charge of such a battery and/or to provide an alternative energy source for a speaker system, a charging station, a humidifier agent, a hygrometer, a thermostat, and/or a visual display.

In some embodiments, the portable humidors have therein a screen for a visual display. In some embodiments, the visual display is configured to receive a wireless signal (eg., Bluetooth transmission (e.g., Bluetooth transmission from a smart phone, smart tablet, portable computer, desktop computer, etc.)). In some embodiments, the audio speakers are configured with a cord based plug for purposes of receiving a video transmission (e.g., a cord based plug to communicate with a smart phone, smart tablet, portable computer, desktop computer, etc.). The embodiments of the present invention are not limited to a particular type and/or kind of visual display. The embodiments of the present invention are not limited to a particular size of visual display. In some embodiments, the size of the visual display is such that it can be positioned within the portable humidor without compromising the ability of the portable humidor to store its cigars and transmit sound (e.g., through its audio speakers). In some embodiments, the visual display is manually adjustable.

In some embodiments, the portable humidors of the present invention are configured with a processor for communicating with an external, wireless signal (e.g., a Bluetooth signal from a smart phone, smart tablet, etc.). In some embodiments, the processor is configured to receive and relay such a signal to the audio speakers. In some embodiments, a smart phone and/or smart tablet “application” is provided to facilitate communication between the portable humidor and a smart phone and/or smart tablet.

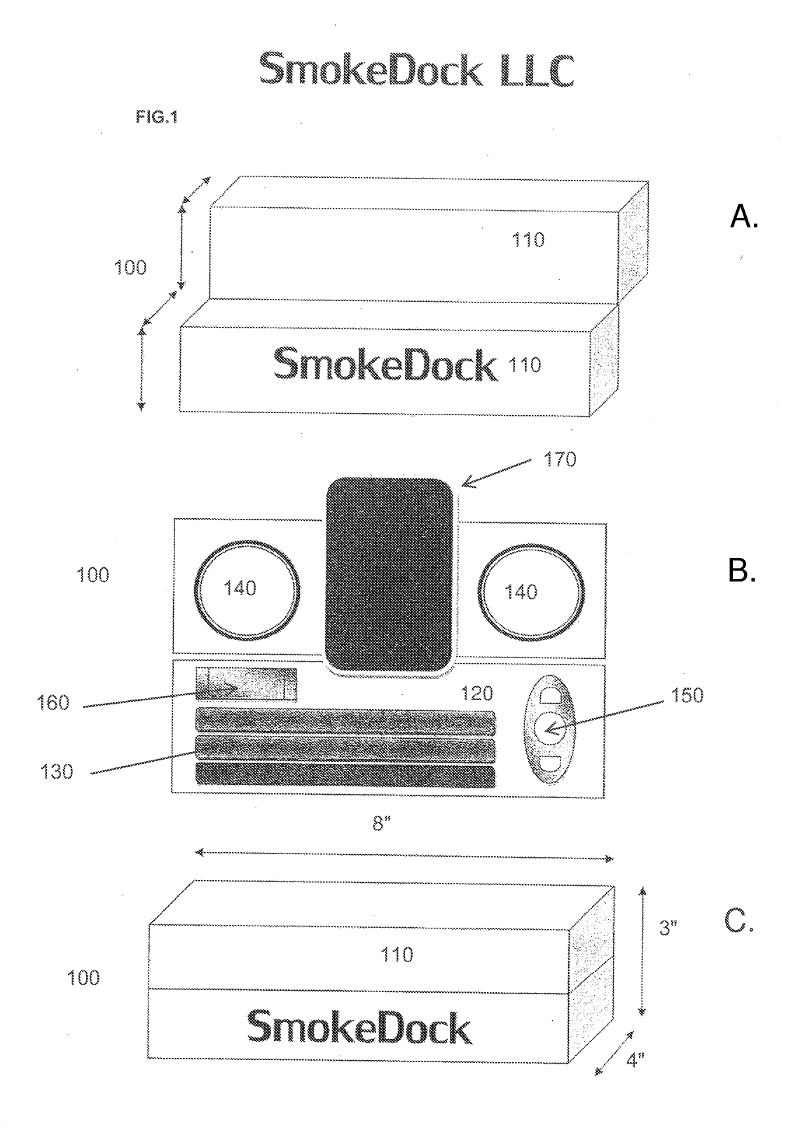

FIG. 1 presents portable humidor embodiments of the present invention.

FIG. 1A shows a portable humidor 100 in an open position. As shown, the portable humidor 100 is shown from a back perspective wherein the exterior region 110 is visible.

FIG. 1B shows the interior region 120 of a portable humidor 100. As shown, three cigars are shown stored in a cigar storing region 130, audio speakers 140 are shown, a cutting device is shown stored in a cutting device storing region 150, an igniting device is shown stored in a igniting device storing region 160, and a smart phone is shown stored in a smart phone storing region 170.

FIG. 1C shows a portable humidor 100 in a closed position. As shown, the portable humidor 100 is shown from a front perspective with its exterior region 110 visible.

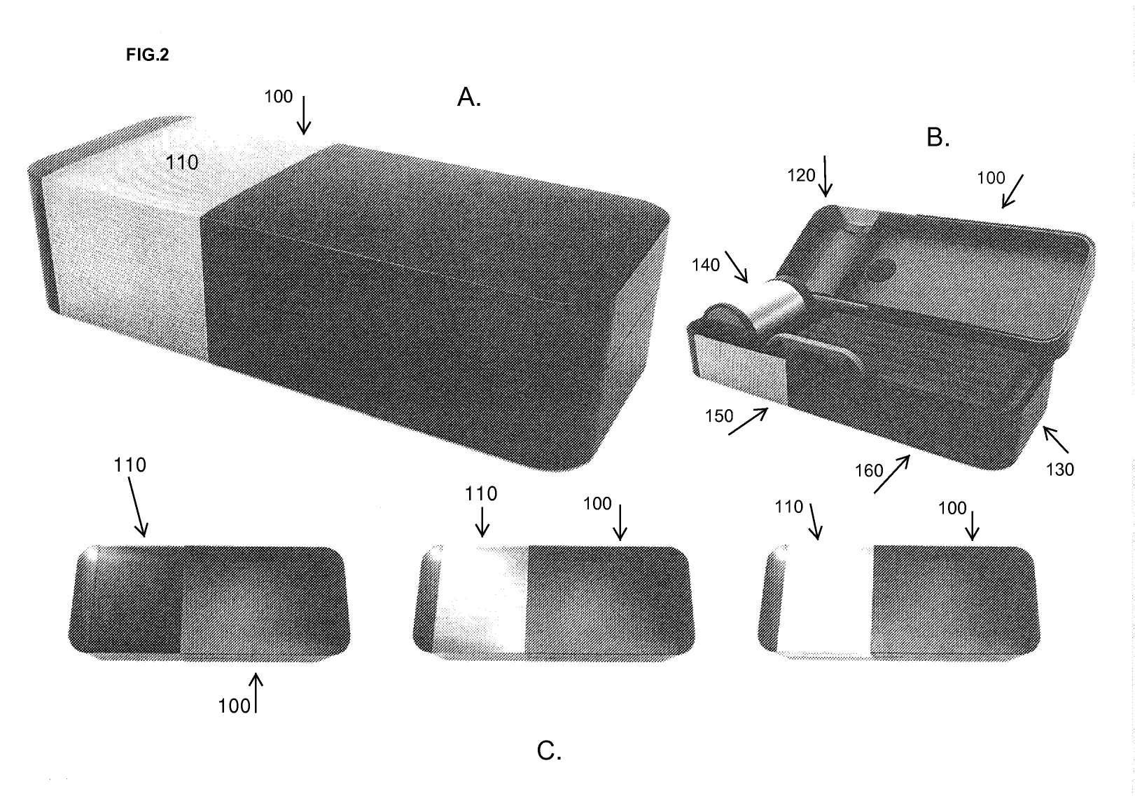

FIG. 2 presents portable humidor embodiments of the present invention.

FIGS. 2A and 2C show portable humidors 100 in closed positions. As shown, the portable humidor 100 embodiments are shown from a front perspective with respective exterior regions 110 visible.

FIG. 2 shows the interior region 120 of a portable humidor 100 embodiment. As shown, five cigars are shown stored in a cigar storing region 130, an audio speaker 140 is shown, a cutting device is shown stored in a cutting device storing region 150, and an igniting device is shown stored in a igniting device storing region 160.

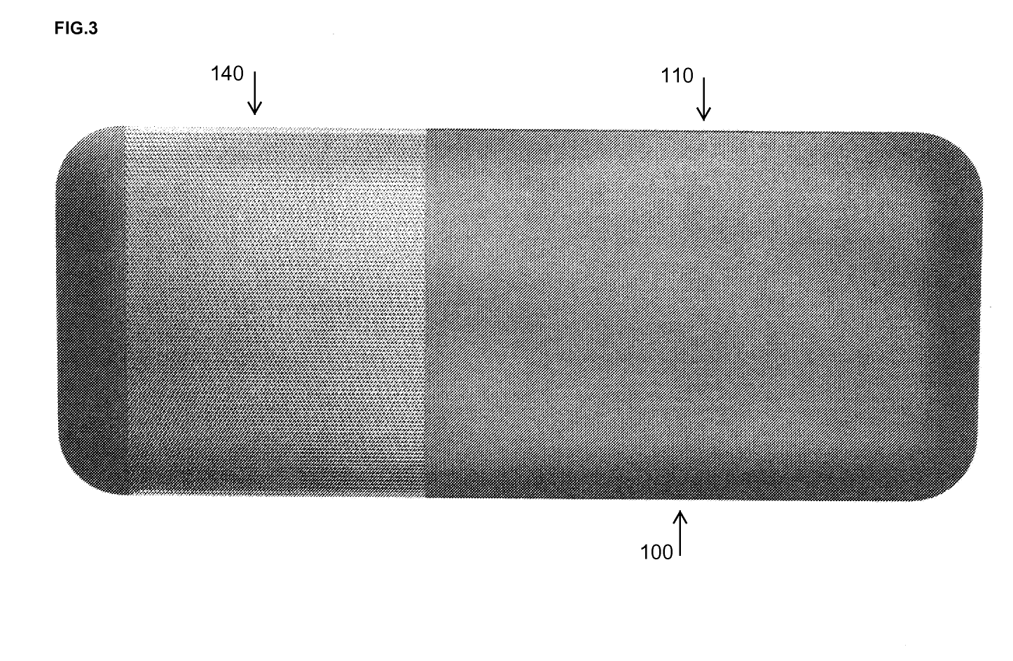

FIG. 3 presents a top down perspective of a portable humidor embodiment of the present invention in a closed position. As shown, the audio speaker 140 is positioned within the exterior region 110 of the portable humidor 100.

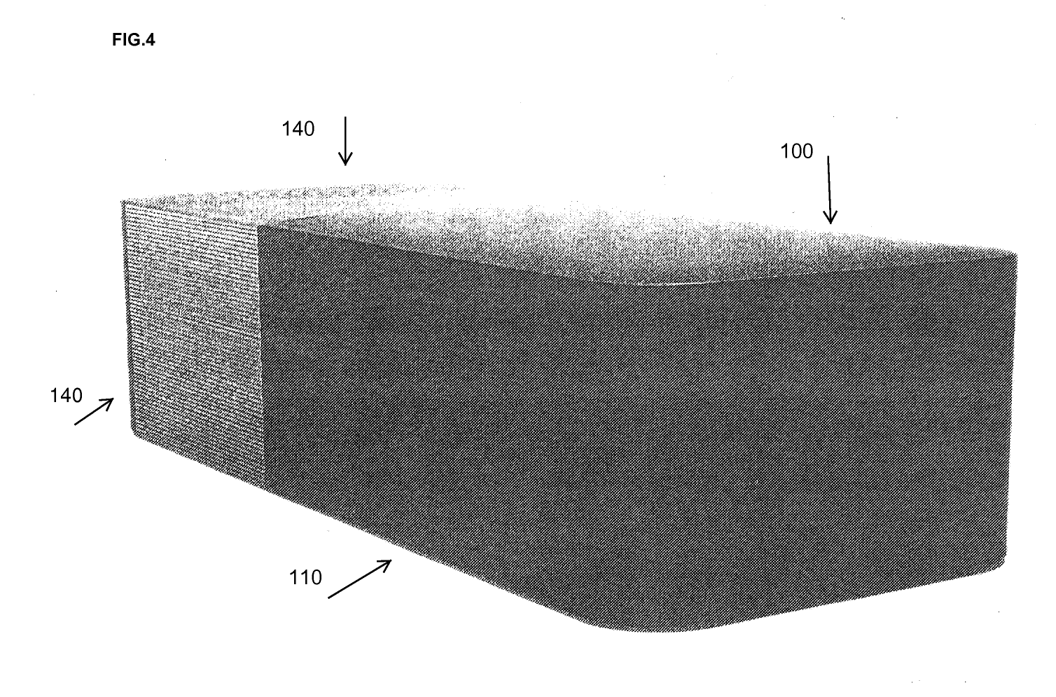

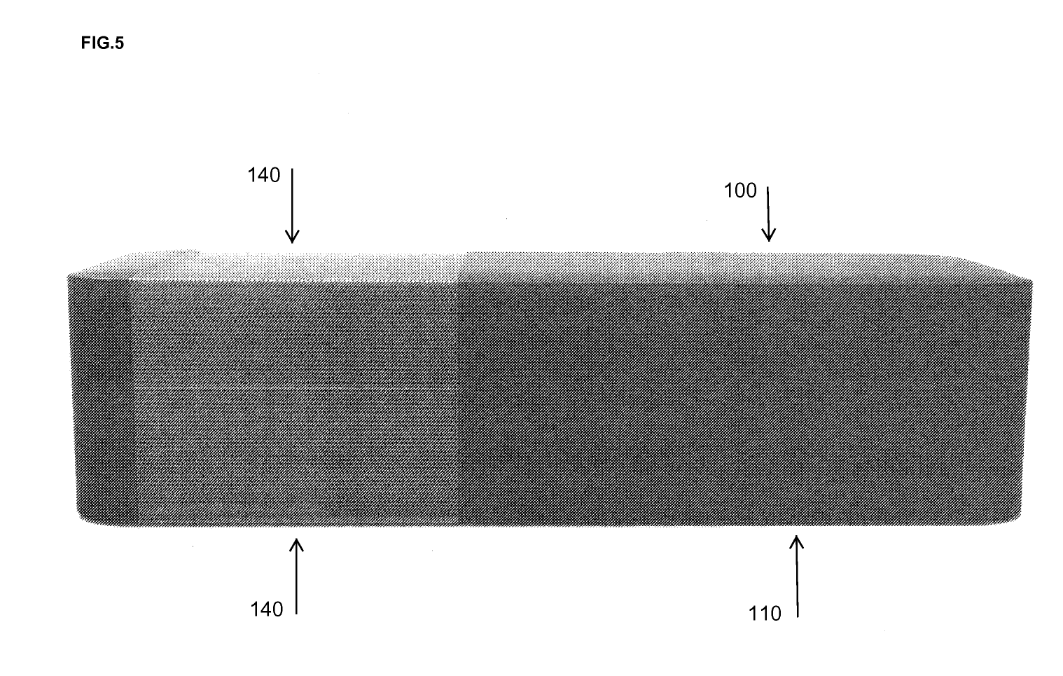

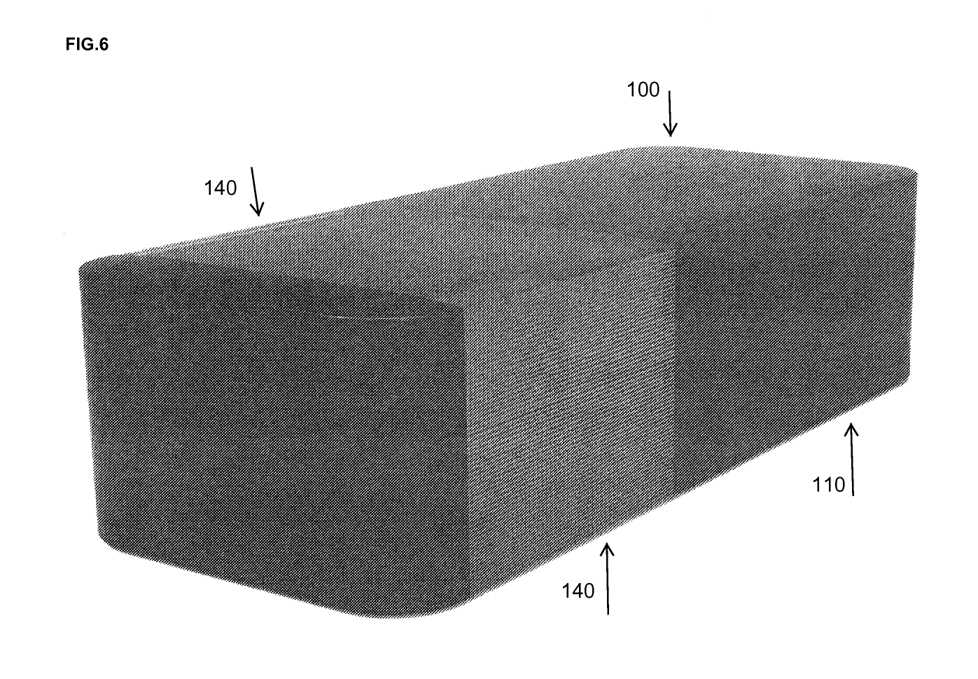

FIGS. 4, 5 and 6 present top-down side-view perspectives or side-view perspectives of portable humidor embodiments of the present invention in a closed position. As shown, the audio speaker 140 is positioned within the exterior region 110 of the portable humidor 100.

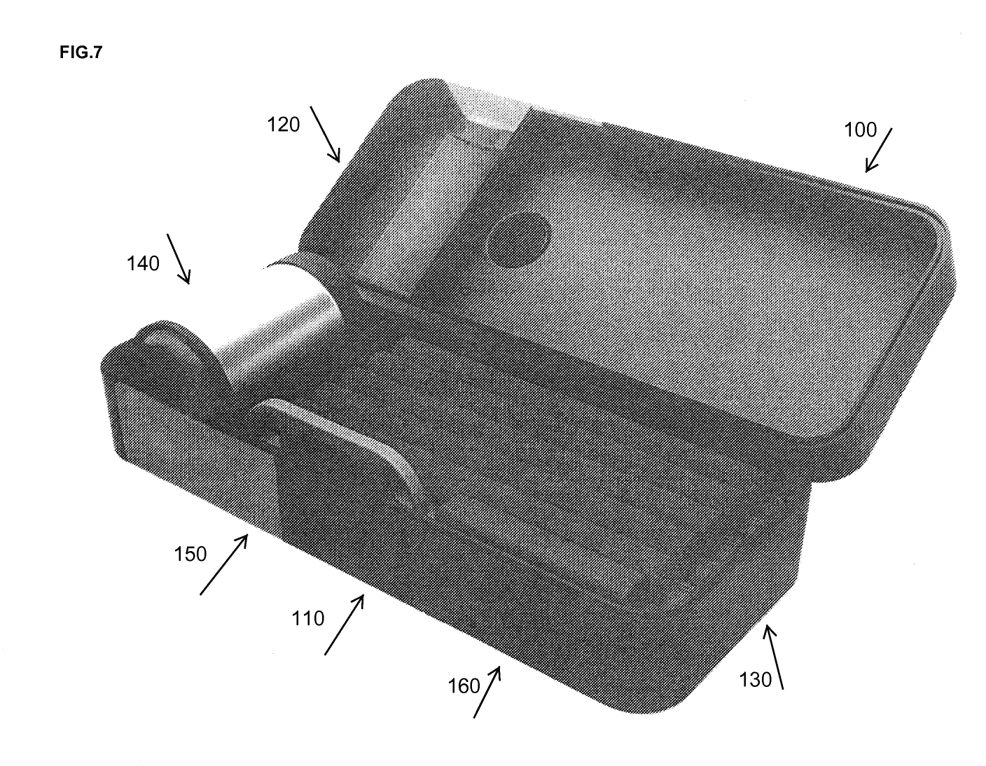

FIG. 7 shows the interior region 120 of a portable humidor 100 embodiment. As shown, five cigars are shown stored in a cigar storing region 130, an audio speaker 140 is shown, a cutting device is shown stored in a cutting device storing region 150, and an igniting device is shown stored in a igniting device storing region 160.

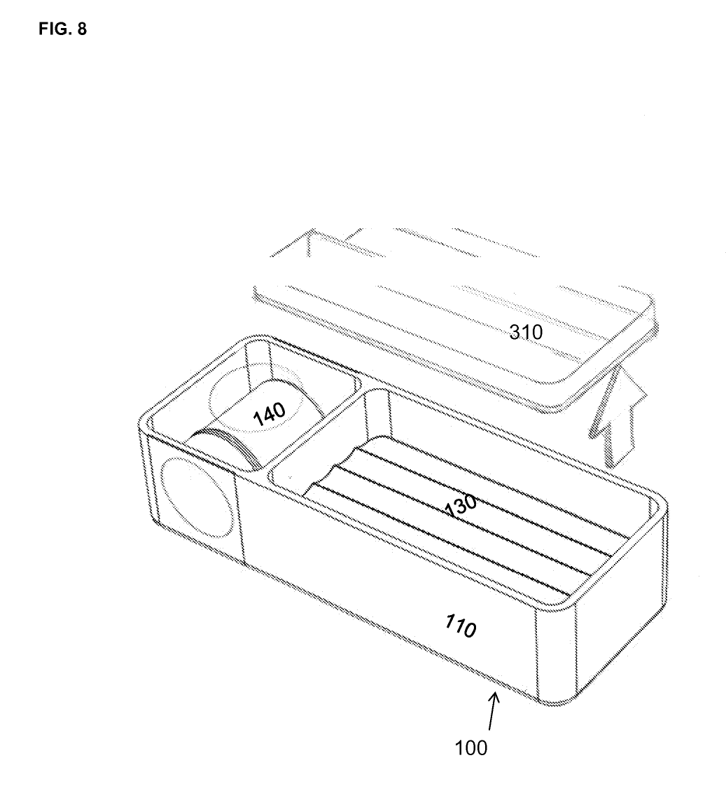

FIG. 8 shows the interior region 120 and exterior region 110 of a portable humidor 100 embodiment. A cigar storing region 130, an audio speaker 140, and a lift-out tray 300 is shown. As shown, the lift-out tray 300 is configured to be removed from the portable humidor 100 thereby permitting access to the cigar storing region 130. In addition, as shown, the lift-out tray 300 has thereon an elevated region 310 generating two separated regions.

The portable humidors of the present invention differ from what current portable humidors. Indeed, current travel humidors are not configured to communicate with, for example, smart phones, smart tablets, laptop computers, desktop computers (e.g., for purposes of receiving and transmitting an audio and/or visual signal). The portable humidors of the present invention prevent individuals from forgetting to pack one of the multiple items needed to enjoy a cigar (e.g., cutter, lighter, etc.) when on a business trip or vacation or, if merely stepping onto a patio or deck, it takes just one empty hand to bring everything they need outside to simultaneously enjoy a cigar and an audio signal (e.g., music).

We claim:

1. A portable humidor comprising an interior region and an exterior region,
the interior region comprising
a region for storing one or more smokable items,
one or more audio speakers,
the exterior region having a top portion and a bottom portion connected in a manner permitting the portable humidor to open and close in an airtight manner.

2. The portable humidor of claim 1, wherein the interior region further comprises a removable lift-out tray configured to be positioned above the region for storing one or more smokable items.

3. The portable humidor of claim 2, wherein positioning of the removable lift-out tray above the region for storing one or more smokable items results in an air-tight seal.

4. The portable humidor of claim 1, wherein the smokable items are cigars and/or cigarettes.

5. The portable humidor of claim 1, wherein the interior region further comprises a region to store an igniting agent.

6. The portable humidor of claim 1, wherein the interior region further comprises a region to store a cigar cutting agent.

7. The portable humidor of claim 1, wherein the one or more speakers are configured to receive and emit a wireless audio signal from a smart phone and/or smart tablet.

8. The portable humidor of claim 1, wherein the one or more speakers are configured to emit an audio signal with the exterior region in an open or closed position.

9. The portable humidor of claim 1, wherein the interior region further comprises a battery configured to provide operating energy to the one or more audio speakers.

10. The portable humidor of claim 1, wherein the interior region further comprises a smart phone and/or smart tablet docking station.

11. The portable humidor of claim 7, wherein the interior region further comprises a processor for facilitating communication between the wireless signal and the audio speakers.

12. The portable humidor of claim 11, wherein the processor communicates with a smart phone and/or smart tablet via an application stored on the smart phone and/or smart tablet.

13. The portable humidor of claim 12, wherein the application permits wireless regulation of the audio speakers from the smart phone and/or smart tablet.

14. The portable humidor of claim 1, wherein the top portion is connected with the bottom portion via a hinge connection.

15. The portable humidor of claim 1, wherein the top portion is connected with the bottom portion via a hingeless connection.

16. The portable humidor of claim 15, wherein the top portion and the bottom portion have thereon one or more opposing magnets.

17. The portable humidor of claim 16, wherein the top portion is connected with the bottom portion via magnetic force.
